(19) United States
(12) Patent Application Publication
(10) Pub. No.: US 2018/0077605 A1
(43) Pub. Date: Mar. 15, 2018

(54) METHODS AND APPARATUS FOR FORMATTING A PROTOCOL DATA UNIT FOR WIRELESS COMMUNICATION

(71) Applicant: QUALCOMM Incorporated, San Diego, CA (US)

(72) Inventors: Shailesh Maheshwari, San Diego, CA (US); Gavin Bernard Horn, La Jolla, CA (US); Vanitha Kumar, San Diego, CA (US); Sitaramanjaneyulu Kanamarlapudi, San Diego, CA (US); Liangchi Hsu, San Diego, CA (US)

(21) Appl. No.: 15/699,916

(22) Filed: Sep. 8, 2017

Related U.S. Application Data
(60) Provisional application No. 62/385,742, filed on Sep. 9, 2016.
(60) Provisional application No. 62/410,807, filed on Oct. 20, 2016.
(60) Provisional application No. 62/442,339, filed on Jan. 4, 2017.

(51) Int. Cl. H04W 28/06; H04L 29/08

(52) U.S. Cl. CPC H04W 28/06; H04L 69/324; H04L 69/321

(57) ABSTRACT

Aspects of the present disclosure provide various apparatuses and methods for formatting and decoding a protocol data unit (PDU) or data packet such that header size and packet processing time at the transmitter and/or receiver can be reduced. The proposed PDU formats may facilitate more efficient packet processing at a medium access control (MAC) layer, a radio link control (RLC) layer, and/or a packet data convergence protocol (PDCP) layer, and less dependent on the number of service data units (SDUs) included in a PDU.

### PRIORITY CLAIM

This application claims priority to and the benefit of U.S. provisional patent application No. 62/442,339 filed on Jan. 4, 2017, U.S. provisional patent application No. 62/385,742 filed on Sep. 9, 2016, and U.S. provisional patent application No. 62/410,807 filed on Oct. 20, 2016, the entire contents of these applications are incorporated herein by reference as if fully set forth below in their entirety and for all applicable purposes.

### TECHNICAL FIELD

The technology discussed below relates generally to wireless communication systems, and more particularly, to protocol data unit formats for wireless communication. Embodiments can provide and enable techniques for reducing packet sizes and packet processing time.

### INTRODUCTION

Aspects of the next generation multiple access technologies such as fifth generation (5G) New Radio (NR) communications technology may support more diverse usage scenarios and applications as compared to legacy mobile networks (e.g., 3G and 4G networks). As the number of data packets being transmitted increases with 5G NR, techniques are needed to provide more efficient and improved processes when formatting and decoding a protocol data unit (PDU) during wireless communications. Some non-limiting examples of PDUs are medium access control (MAC) layer PDUs, radio link control (RLC) layer PDUs, and packet data convergence protocol (PDCP) layer PDUs. In certain instances, as the next generation wireless networks come into existence, specific latency and reliability requirements are needed to be met in order to support the usage scenarios and applications of next generation wireless communications. Thus, improvements in formatting a PDU or data packet, in particular, its header, during wireless communication are desired.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide various apparatuses and methods for formatting and decoding a protocol data unit (PDU) or data packet such that header size and packet processing time at the transmitter and/or receiver can be reduced. In various aspects of the disclosure, the proposed PDU formats may facilitate more efficient packet processing at a medium access control (MAC) layer, a radio link control (RLC) layer, and/or a packet data convergence protocol (PDCP) layer, and less dependent on the number of service data units (SDUs) included in a PDU.

An aspect of the present disclosure provides a method of wireless communication. An apparatus receives a plurality of service data units (SDUs) from a network protocol layer. The apparatus forms a header including a plurality of service data unit (SDU) length fields each representing a different length of the plurality of SDUs. The header is configured to indicate a quantity of the SDUs having a same length. The apparatus forms a packet data unit (PDU) including the header and a payload field that includes the plurality of SDUs. The apparatus transmits the PDU to a peer entity.

Another aspect of the present disclosure provides a method of wireless communication. An apparatus receives a protocol data unit (PDU) from a peer entity, the PDU including a header and a payload field that includes one or more service data units (SDUs). The header is configured to indicate a quantity of the SDUs having a same length. The apparatus decodes the header to determine a plurality of service data unit (SDU) length fields each representing a different length of the plurality of SDUs. The apparatus decodes the payload field to extract the one or more SDUs according to the plurality of SDU length fields.

Another aspect of the present disclosure provides an apparatus that includes a communication interface configured for wireless communication, a memory, and a processor operatively coupled to the communication interface and the memory. The processor and the memory are configured to receive a plurality of service data units (SDUs) from a network protocol layer. The processor and the memory are configured to form a header including a plurality of service data unit (SDU) length fields each representing a different length of the plurality of SDUs. The header is configured to indicate a quantity of the SDUs having a same length. The processor and the memory are configured to form a packet data unit (PDU) including the header and a payload field that includes the plurality of SDUs. The processor and the memory are configured to transmit the PDU to a peer entity.

Another aspect of the present disclosure provides an apparatus including a communication interface configured for wireless communication, a memory, and a processor operatively coupled to the communication interface and the memory. The processor and the memory are configured to receive a protocol data unit (PDU) from a peer entity. The PDU includes a header and a payload field that includes one or more service data units (SDUs). The header is configured to indicate a quantity of the SDUs having a same length. The processor and the memory are configured to decode the header to determine a plurality of service data unit (SDU) length fields each representing a different length of the plurality of SDUs. The processor and the memory are configured to decode the payload field to extract the one or more SDUs according to the plurality of SDU length fields.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a radio access network according to some aspects of the disclosure.

FIG. 2 is a block diagram conceptually illustrating an example of a scheduling entity communicating with one or more scheduled entities according to some aspects of the disclosure.

FIG. 3 is a diagram illustrating an exemplary network protocol stack according to some aspects of the disclosure.

FIG. 4 is a block diagram illustrating an example of a hardware implementation for a scheduling entity employing a processing system according to some aspects of the disclosure.

FIG. 5 is a block diagram illustrating an example of a hardware implementation for a scheduled entity employing a processing system according to some aspects of the disclosure.

FIG. 6 is a diagram illustrating an exemplary protocol data unit (PDU) format according to some aspects of the disclosure.

FIG. 7 is a diagram illustrating a medium access control (MAC) PDU according to an aspect of the disclosure.

FIG. 8 is a diagram illustrating an exemplary MAC header according to an aspect of the disclosure.

FIG. 9 is a diagram illustrating an exemplary MAC header according to an aspect of the disclosure.

FIG. 10 is a diagram illustrating another exemplary MAC header according to an aspect of the disclosure.

FIG. 11 is a diagram illustrating another exemplary MAC header according to an aspect of the disclosure.

FIG. 12 is a diagram illustrating an exemplary radio link control (RLC) header according to an aspect of the disclosure.

FIG. 13 is a diagram illustrating another exemplary RLC header according to an aspect of the disclosure.

FIG. 14 is a diagram illustrating another exemplary RLC header according to an aspect of the disclosure.

FIG. 15 is a diagram illustrating an exemplary packet data convergence protocol (PDCP) header according to an aspect of the disclosure.

FIG. 16 is a flow chart illustrating an exemplary process for formatting a PDU according to some aspects of the disclosure.

FIG. 17 is a flow chart illustrating an exemplary process for decoding a PDU in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure provide various apparatuses and methods for formatting and decoding a protocol data unit (PDU) or data packet such that header size and packet processing time at the transmitter and/or receiver can be reduced. In various aspects of the disclosure, the proposed PDU formats may facilitate more efficient packet processing at a medium access control (MAC) layer, a radio link control (RLC) layer, and/or a packet data convergence protocol (PDCP) layer, and less dependent on the number of service data units (SDUs) included in a PDU. When the PDU includes multiple SDUs, a header or subheader of the PDU may provide various information on the SDUs. According to aspects of the disclosure, the header or subheader may be formatted to reduce redundant information to facilitate faster and more efficient processing of the SDUs collectively instead of individually. The header formats described herein may be applied to various wireless standards including next generation networks like 5G New Radio (NR) and legacy networks.

### Radio Access Network

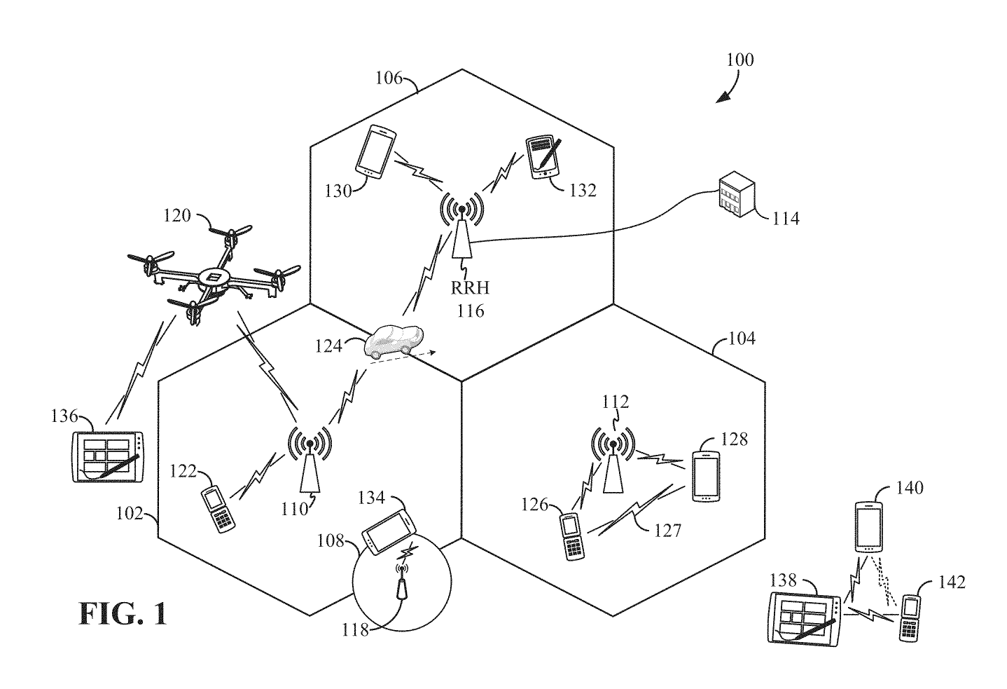

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The radio access network 100 may be a next generation network like 5G NR.

The geographic region covered by the radio access network 100 may be divided into a number of cellular regions (cells) that can be uniquely identified by a user equipment (UE) based on an identification broadcasted over a geographical area from one access point or base station. FIG. 1 illustrates macrocells 102, 104, and 106, and a small cell 108, each of which may include one or more sectors. A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

In FIG. 1, two high-power base stations 110 and 112 are shown in cells 102 and 104; and a third high-power base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the high-power base stations 110, 112, and 114 support cells having a large size. Further, a low-power base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the low-power base station 118 supports a cell having a relatively small size. Cell sizing can be done according to system design as well as component constraints. It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion of the network. The backhaul may provide a link between a base station and a core network, and in some examples, the backhaul may provide interconnection between the respective base stations. The core network is a part of a wireless communication system that is generally independent of the radio access technology used in the radio access network. Various types of backhaul interfaces may be employed, such as a direct physical connection, a virtual network, or the like using any suitable transport network. Some base stations may be configured as integrated access and backhaul (IAB) nodes, where the wireless spectrum may be used both for access links (i.e., wireless links with UEs), and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks.

The radio access network 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the radio access network 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with low-power base station 118; and UE 136 may be in communication with mobile base station 120. Here, each base station 110, 112, 114, 118, and 120 may be configured to provide an access point to a core network (not shown) for all the UEs in the respective cells. Transmissions from a base station (e.g., base station 110) to one or more UEs (e.g., UEs 122 and 124) may be referred to as downlink (DL) transmission, while transmissions from a UE (e.g., UE 122) to a base station may be referred to as uplink (UL) transmissions. In accordance with certain aspects of the present disclosure, the term downlink may refer to a point-to-multipoint transmission originating at a scheduling entity 202. Another way to describe this scheme may be to use the term broadcast channel multiplexing. In accordance with further aspects of the present disclosure, the term uplink may refer to a point-to-point transmission originating at a scheduled entity 204.

In some examples, a mobile network node (e.g., quadcopter 120) may be configured to function as a UE. For example, the quadcopter 120 may operate within cell 102 by communicating with base station 110. In some aspects of the disclosure, two or more UE (e.g., UEs 126 and 128) may communicate with each other using peer to peer (P2P) or sidelink signals 127 without relaying that communication through a base station (e.g., base station 112).

### Mobility

In the radio access network 100, the ability for a UE to communicate while moving, independent of its location, is referred to as mobility. The various physical channels between the UE and the radio access network are generally set up, maintained, and released under the control of an access and mobility management function (AMF), which may include a security context management function (SCMF) that manages the security context for both the control plane and the user plane functionality, and a security anchor function (SEAF) that performs authentication. In various aspects of the disclosure, a radio access network 100 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 (illustrated as a vehicle, although any suitable form of UE may be used) may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each

UE may be utilized by the network to select a serving cell for each UE. In some examples, the base stations 110, 112, and 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, and 132 may receive the unified synchronization signals, derive the carrier frequency and slot timing from the synchronization signals, and in response to deriving timing, transmit an uplink pilot or reference signal. The uplink pilot signal transmitted by a UE (e.g., UE 124) may be concurrently received by two or more cells (e.g., base stations 110 and 114/116) within the radio access network 100. Each of the cells may measure a strength of the pilot signal, and the radio access network (e.g., one or more of the base stations 110 and 114/116 and/or a central node within the core network) may determine a serving cell for the UE 124. As the UE 124 moves through the radio access network 100, the network may continue to monitor the uplink pilot signal transmitted by the UE 124. When the signal strength or quality of the pilot signal measured by a neighboring cell exceeds that of the signal strength or quality measured by the serving cell, the network 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

### Communication Entities

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). In other examples, sidelink signals may be used between UEs without necessarily relying on scheduling or control information from a base station. For example, UE 138 is illustrated communicating with UEs 140 and 142. In some examples, the UE 138 is functioning as a scheduling entity or a primary sidelink device, and UEs 140 and 142 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 140 and 142 may optionally communicate directly with one another in addition to communicating with the scheduling entity 138.

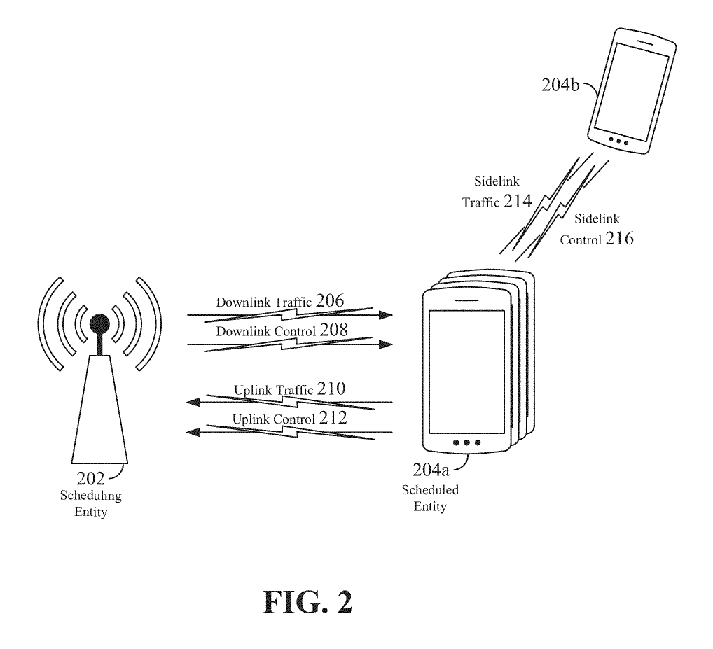

Thus, in a wireless communication network with scheduled access to time-frequency resources and having a cellular configuration, a P2P configuration, or a mesh configuration, a scheduling entity and one or more scheduled entities may communicate utilizing the scheduled resources. Referring now to FIG. 2, a block diagram illustrates a scheduling entity 202 and a plurality of scheduled entities 204 (e.g., 204a and 204b). Here, the scheduling entity 202 may correspond to a base station 110, 112, 114, and/or 118. In additional examples, the scheduling entity 202 may correspond to a UE 138, the quadcopter 120, or any other suitable node in the radio access network 100. Similarly, in various examples, the scheduled entity 204 may correspond to the UE 122, 124, 126, 128, 130, 132, 134, 136, 138, 140, and 142, or any other suitable node in the radio access network 100.

Referring to FIG. 2, the scheduling entity 202 may broadcast traffic 206 to one or more scheduled entities 204 (the traffic may be referred to as downlink traffic). Broadly, the scheduling entity 202 is a node or device responsible for scheduling traffic in a wireless communication network, including the downlink transmissions and, in some examples, uplink traffic 210 from one or more scheduled entities to the scheduling entity 202. Broadly, the scheduled entity 204 is a node or device that receives control information, including but not limited to scheduling information (e.g., a grant), synchronization or timing information, or other control information from another entity in the wireless communication network such as the scheduling entity 202. In some examples, the scheduling entity 202 may be a base station or gNB, and the scheduled entities 204 may be UEs.

### Sidelink

In some examples, scheduled entities such as a first scheduled entity 204a and a second scheduled entity 204b may utilize sidelink signals for direct D2D communication. Sidelink signals may include sidelink traffic 214 and sidelink control 216. Sidelink control information 216 may in some examples include a request signal, such as a request-to-send (RTS), a source transmit signal (STS), and/or a direction selection signal (DSS). The request signal may provide for a scheduled entity 204 to request a duration of time to keep a sidelink channel available for a sidelink signal. Sidelink control information 216 may further include a response signal, such as a clear-to-send (CTS) and/or a destination receive signal (DRS). The response signal may provide for the scheduled entity 204 to indicate the availability of the sidelink channel, e.g., for a requested duration of time. An exchange of request and response signals (e.g., handshake) may enable different scheduled entities performing sidelink communications to negotiate the availability of the sidelink channel prior to communication of the sidelink traffic information 214.

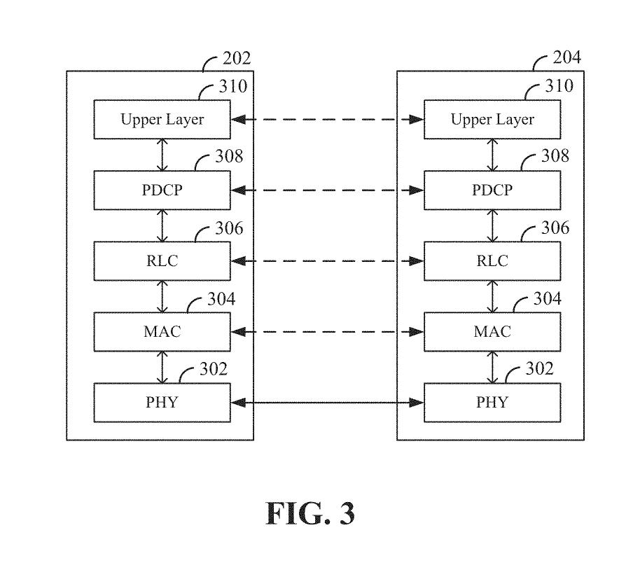

FIG. 3 is a diagram illustrating various network protocol entities of the scheduling entity 202 and the scheduled entities 204 according to some aspects of the disclosure. The scheduling entity 202 and the scheduled entities 204 each have a PHY layer entity 302 that implements various physical layer communication functions. Other protocol layer entities are a media access control (MAC) layer entity 304, a radio link control (RLC) layer entity 306, and a packet data convergence protocol (PDCP) layer entity 308. Upstream of the PDCP layer may be one or more upper layer entities, for example, an RRC layer entity, an IP layer entity, and an application layer. Each network layer entity at the scheduling entity 202 communicates with a corresponding peer entity at the scheduled entity 204.

The PDCP layer entity 308 may provide multiplexing between different radio bearers and logical channels. The PDCP layer also may provide header compression for upper layer data packets to reduce radio transmission overhead, security by ciphering the data packets, and handover support for scheduled entities between scheduling entities. The RLC layer entity 306 may provide segmentation and reassembly of upper layer data packets (e.g., PDCP protocol data units (PDUs), IP packets), retransmission of lost data packets, and reordering of data packets to compensate for out-of-order reception due to hybrid automatic repeat request (HARQ). The MAC layer entity 304 may provide multiplexing functions between logical and transport channels. The MAC layer entity may also be responsible for allocating various time-frequency resources (e.g., resource blocks) in one cell among the scheduled entities (e.g., UEs). The MAC layer entity may also be responsible for HARQ operations.

### Duplexing

Referring back to FIG. 1, the air interface in the radio access network 100 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at sometimes the channel is dedicated for transmissions in one direction, while at other times the channel is dedicated for transmissions in the other direction, where the direction may change very rapidly, e.g., several times per slot.

### Channel Coding

Transmissions over the radio access network 100 may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise. Some examples of error correcting codes include Hamming codes, Bose-Chaudhuri-Hocquenghem (BCH) codes, Turbo codes, low-density parity check (LDPC) codes, and Polar codes. Various implementations of scheduling entities 202 and scheduled entities 204 may include suitable hardware and capabilities (e.g., an encoder, a decoder, and/or a CODEC) to utilize one or more of these error correcting codes for wireless communication.

### Multiplexing/Multiple Access

The air interface in the radio access network 100 may utilize one or more multiplexing and multiple access algorithms to enable simultaneous communication of the various devices. For example, multiple access for uplink (UL) or reverse link transmissions from UEs 122 and 124 to base station 110 may be provided utilizing time division multiple access (TDMA), code division multiple access (CDMA), frequency division multiple access (FDMA), orthogonal frequency division multiple access (OFDMA), discrete Fourier transform (DFT)-spread OFDMA or single-carrier FDMA (DFT-s-OFDMA or SC-FDMA), sparse code multiple access (SCMA), resource spread multiple access (RSMA), or other suitable multiple access schemes. Further, multiplexing downlink (DL) or forward link transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

### Scheduling Entity

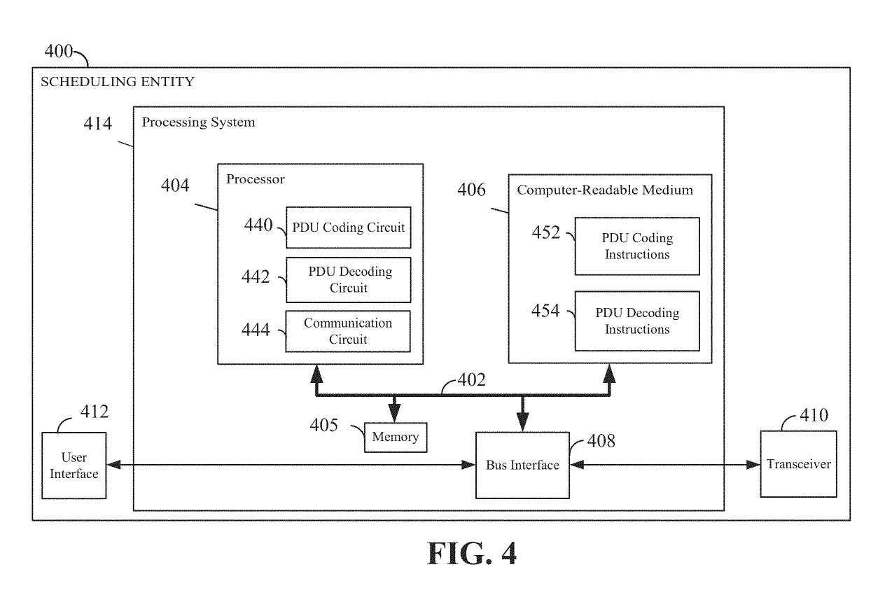

FIG. 4 is a block diagram illustrating an example of a hardware implementation for a scheduling entity 400 employing a processing system 314. For example, the scheduling entity 400 may be a user equipment (UE) as illustrated in any one or more of FIGS. 1, 2, and/or 3. In another example, the scheduling entity 400 may be a base station as illustrated in any one or more of FIGS. 1, 2, and/or 3.

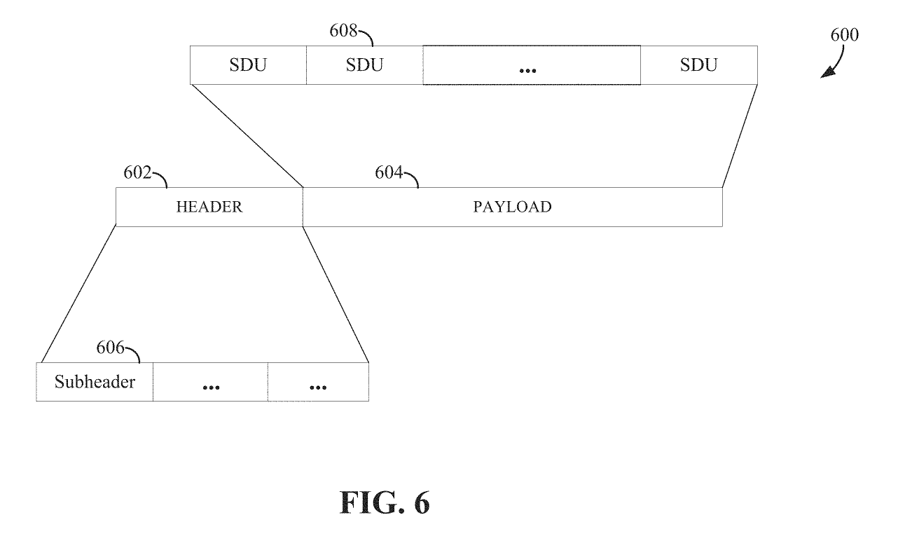

The scheduling entity 400 may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 400 may be configured to perform any one or more of the functions described herein. That is, the processor 404, as utilized in a scheduling entity 400, may be used to implement any one or more of the processes and procedures described and illustrated in relation to FIGS. 6-17.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a communication interface or means for communicating with various other apparatus over a transmission medium. Depending upon the nature of the apparatus, a user interface 412 (e.g., keypad, display, speaker, microphone, joystick) may also be provided.

In some aspects of the disclosure, the processor 404 may include circuitry configured for various functions, for example, a PDU coding circuit 440, a PDU decoding circuit 442, and a communication circuit 444. The PDU coding circuit 440 in connection with PDU coding instructions 452, can be configured to implement one or more of the functions and procedures to form a PDU according to various PDU formats illustrated in FIGS. 6-15. The PDU coding circuit 440 can receive SDUs from a network protocol layer, for example, an IP layer, a PDCP layer, or an RLC layer. The PDU coding circuit may implement one or more network protocol layers or entities similar to those illustrated in FIG. 3. The PDU coding circuit 440 may have one or more buffers for receiving and storing data packets or SDUs from different network protocol layers.

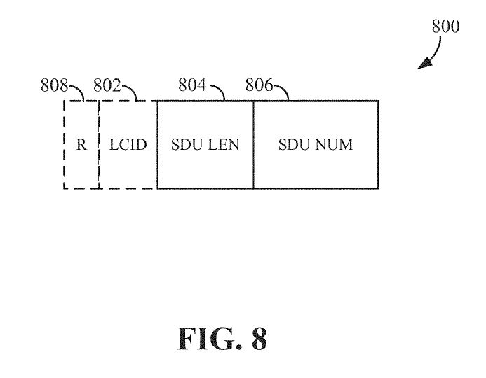

In some aspects of the disclosure, the PDU coding circuit 440 can form a PDU header or subheader including a plurality of SDU length fields each representing a different length of a plurality of SDUs. The PDU coding circuit 440 can determine the length (bits) of each received SDU and create different SDU length fields to represent different SDU lengths in the same PDU header. For example, the SDU length fields may be the same as any of the SDU LEN fields 804, 910, 1010, 1112, 1208, 1308, 1408, and/or 1508 illustrated in FIGS. 8-15. The PDU coding circuit 440 can form a PDU including the header and a payload field including the plurality of SDUs. For example, the PDU may be a PDCP PDU, an RLC PDU, or a MAC PDU. In some examples, the PDU coding circuit 440 may include circuitry for concatenating, combining, and storing the header and the SDUs. In some examples, the PDU coding circuit 440 may multiplex SDUs from several logical channels into one transport channel.

The processor 404 may include a PDU decoding circuit 442 in connection with PDU decoding instructions 454, can be configured to implement one or more of the functions and procedures to decode a PDU or packet according to various PDU formats illustrated in FIGS. 6-15. The PDU decoding circuit 442 can decode a PDU header to determine a plurality of SDU length fields each representing a different length (e.g., bits) of a plurality of SDUs. In some examples, the PDU decoding circuit 442 may have a header analyzing circuit configured to extract information fields in the header or subheader corresponding to the SDU length fields. For example, the SDU length fields may be the same as any of the SDU LEN fields 804, 910, 1010, 1112, 1208, 1308, 1408, and 1508 illustrated in FIGS. 8-15. The PDU decoding circuit 442 can decode a PDU payload portion to extract the one or more SDUs according to the plurality of SDU length fields. For example, the PDU decoding circuit 442 may have a payload detector configured to detect the payload (e.g., SDUs) and a storage for storing the extracted one or more SDUs. Based on information fields in the header, the PDU decoding circuit 442 can determine the size of the entire header and/or the location of the payload within the PDU without processing the entire header.

The processor 404 may include a communication circuit 444 in connection with the transceiver 410 can be configured to transmit and/or receive a PDU to/from a peer entity. For example, the PDU may be any of the PDCP PDU, RLC PDU, or MAC PDU illustrated in FIGS. 6-15. The communication circuit may receive the PDU via a lower protocol layer, for example, a physical layer, a MAC layer, an RLC layer, or a PDCP layer.

The processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 and the memory 405 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Scheduled Entity

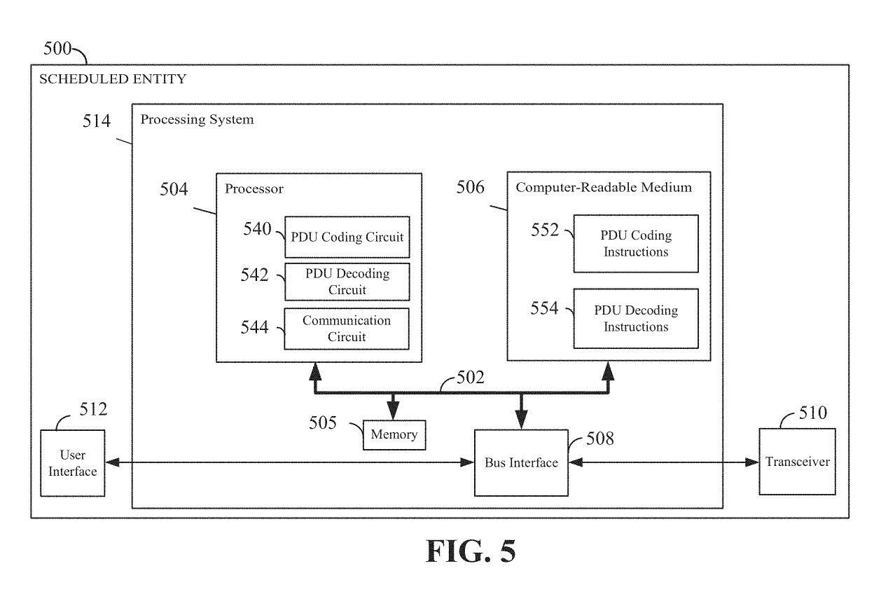

FIG. 5 is a conceptual diagram illustrating an example of a hardware implementation for an exemplary scheduled entity 500 employing a processing system 514. In accordance with various aspects of the disclosure, an element, or any portion of an element, or any combination of elements may be implemented with a processing system 514 that includes one or more processors 504. For example, the scheduled entity 500 may be a user equipment (UE) as illustrated in any one or more of FIGS. 1, 2, and/or 3.

The processing system 514 may be substantially the same as the processing system 414 illustrated in FIG. 4, including a bus interface 508, a bus 502, memory 505, a processor 504, and a computer-readable medium 506. Furthermore, the scheduled entity 500 may include a user interface 512 and a transceiver 510 substantially similar to those described above in FIG. 4. That is, the processor 504, as utilized in a scheduled entity 500, may be used to implement any one or more of the processes and functions described in relation to FIGS. 6-17.

In some aspects of the disclosure, the processor 504 may include circuitry configured for various functions, including, for example, a PDU coding circuit 540, a PDU decoding circuit 542, and a communication circuit 544. These circuits are similar to the PDU coding circuit 440, PDU decoding circuit 442, and communication circuit 444 of FIG. 4 described above. Redundant description will not be repeated.

FIG. 6 is a diagram illustrating an exemplary protocol data unit (PDU) format 600 in accordance with some aspects of the present disclosure. This PDU format 600 may be utilized by any of the scheduling entities and/or scheduled entities illustrated in FIGS. 1-5 for wireless communication. The PDU format 600 may include a header 602 and a payload portion 604. The header 602 can have various formats that can reduce header size and processing overhead at the receiver and/or transmitter. In some examples, the PDU format 600 may be used to implement a MAC PDU, an RLC PDU, a PDCP PDU, and the like. The header 602 may include one or more subheaders 606, and the payload portion 604 may include one or more SDUs 608 and optionally a padding field. Each SDU may carry the PDU of an upper protocol layer. In some examples, the header 602 may have only one subheader 606. In that case, the header 602 and the subheader 606 are the same. In some aspects of the disclosure, the header 602 can have various structures that can provide information on the sizes of the header and payload, and reduce redundant information about the SDUs 608. The header and the payload portion will be described in more detail below using some illustrative examples.

In some aspects of the disclosure, a scheduling or scheduled entity can form a MAC PDU based on the PDU format 600. Each MAC PDU may include one or more SDUs of an upper protocol layer, for example, RLC PDUs. The header of the MAC PDU may include various information, for example, MAC header length, one or more logical channel ID (LCID), and more. The LCID indicates that the corresponding payload is a MAC Control Element or a logical channel to which the related MAC SDU(s) (e.g., RLC PDU or PDCP PDU) belongs. The header may include multiple LCIDs respectively corresponding to SDUs from different logical channels or sources. The MAC header length indicates the total length of the MAC header. In various aspects of the disclosure, the MAC PDU header may further include other fields that will be described in more detail in the following examples.

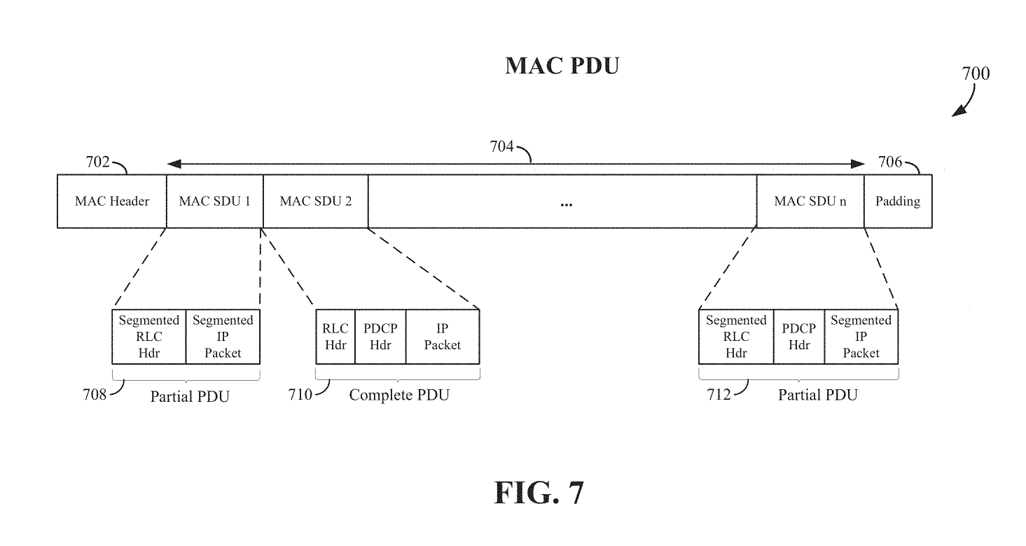

FIG. 7 is a diagram illustrating a MAC PDU 700 in accordance with some aspects of the disclosure. A MAC PDU may correspond to a MAC transport block (TB). The MAC PDU 700 may include a MAC header 702, a number of MAC SDUs 704, and optionally a padding field 706. The MAC header 702 may contain one or more MAC subheaders. In some examples, the MAC SDUs 704 may carry Internet Protocol (IP) traffic packaged in a first partial PDU 708, one or more complete PDUs 710, and a second partial PDU 712. The first partial PDU 708 may include a segmented RLC header and a segmented IP packet that is partially transmitted in a previous TB. The complete PDU 710 may include an RLC header, a PDCP header, and an IP packet. The second partial PDU 712 may include a segmented RLC header, a PDCP header, and a segmented IP packet. The first partial PDU 708 and second partial PDU 712 may be different in packet sizes. Use of Transmission Control Protocol (TCP) communication often results in IP packets of the maximum transmission unit (MTU) size. MTU size is generally used for TCP packets and TCP acknowledgement. Therefore, the complete PDUs 710 (i.e., complete IP packets) often have the same size or length. In some high data rate examples, the traffic pattern is expected to have IP packets of the same size back-to-back. Therefore, the probability of continuous packets having the same length/size will be relatively high in TCP traffic applications as compared to other types of traffic.

In the following examples, aspects of the present disclosure exploit the above described MAC PDU characteristics (e.g., back-to-back packets with the same size) to reduce the MAC header size and/or packet processing overhead by not repeating or reducing certain redundant information and providing a deterministic header size to facilitate faster processing of the PDU. For example, the header may provide information on packets from the same logical channel as a group or collectively. Therefore, redundant information (e.g., LCID, SDU length) needs not to be repeated in the header per packet. In some examples, the MAC header may explicitly provide its length (bits) such that the receiver can determine the size of the header and/or the starting location of the payload within the PDU without processing the entire header.

FIG. 8 is a diagram illustrating an exemplary MAC header 800 in accordance with an aspect of the present disclosure. In some examples, the MAC header 800 may be a subheader included in the MAC header 702 of FIG. 7. The MAC header 800 includes various information fields, for example, LCID 802, a SDU length field 804, and a SDU NUM field 806. The SDU NUM field 806 indicates a quantity of SDUs with a particular size as indicated by the SDU length field 804. In some examples, the MAC header 800 can represent multiple SDUs of the same length/size corresponding to the same LCID or logical channel, and thus, redundant information can be reduced in the MAC header. In some examples, the MAC header 800 may include a reserve bit R 808 that indicates whether the LCID field is present in the header. In certain instances, the reserve bit R 808 may indicate that the LCID is omitted from a certain MAC header 800, for example, when the LCID has not changed and can be inferred from another adjacent or earlier header.

In another example, the MAC header 800 may include a bitmap representing all possible LCIDs, the SDU length(s), and the number of SDUs having the indicated length(s). For example, a certain LCID can be indicated by setting a corresponding bit of the bitmap. In some examples, a MAC header may include one or more subheaders like the MAC header 800 each corresponding to a different combination of the LCID 802 (optionally), SDU LEN 804, and SDU NUM 806. Using the header 800 of FIG. 8, a scheduling or scheduled entity can use a single LCID in the header to represent multiple SDUs with the same length associated with the same LCID.

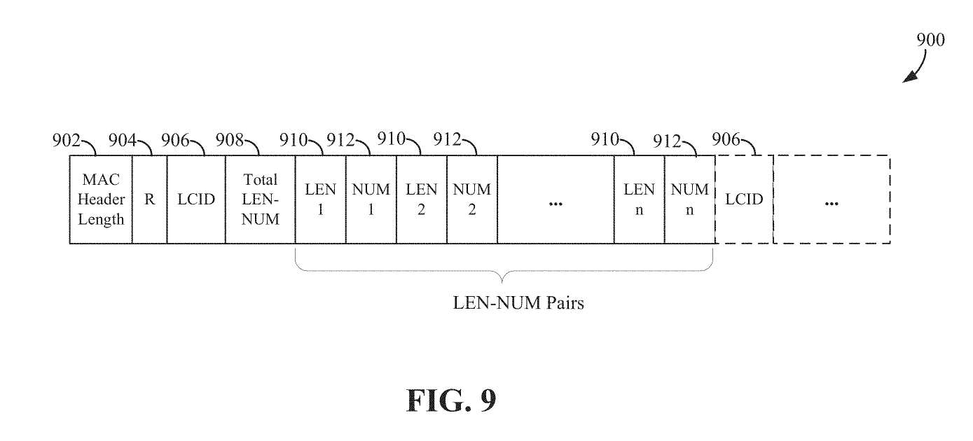

FIG. 9 is a diagram illustrating an exemplary MAC header 900 in accordance with some aspects of the present disclosure. In some examples, the MAC header 900 may be the same as the MAC header 702 of FIG. 7. The MAC header 900 includes various information fields, for example, a MAC header length field 902, an optional reserve (R) field 904, and one or more LCID fields 906. Associated with each LCID field, the MAC header 900 may further include a total LEN-NUM field 908 and one or more pairs of LEN fields 910 and NUM fields 912. The MAC header length field 902 indicates the total length of the entire MAC header 900. A receiver can start processing the payload of a PDU when the header size is known, even if the processing of the header has not been completed yet.

The total LEN-NUM field 908 indicates the total number of LEN-NUM pairs for a certain logical channel identified by the LCID field 906. A LEN-NUM pair refers to a pair of LEN field 910 and NUM field 912. The LEN field 910 indicates the length of a SDU, and the NUM field 912 (a quantity field) indicates the number of SDUs with the same length as indicated by the paired LEN field 910. The MAC header 900 may have any number of LCID fields 906 and associated LEN-NUM pairs. In some examples, the MAC header length field 902 may have 8 bits, the reserve field R 904 may have 3 bits, the LCID field 906 may have 5 bits, the total LEN-NUM field 908 may have 8 bits, the LEN field 910 may have 16 bits, and the NUM field 912 may have 8 bits. In other examples, each field illustrated in FIG. 9 may contain other desired number of bits.

Using the header 900, a scheduling or scheduled entity can use the same LCID in the header across multiple SDUs (e.g., RLC PDUs, PDCP PDUs) associated with the same LCID. Therefore, redundant LCID fields may be avoided. Moreover, the MAC header length is known (indicated by the MAC header length 902) so that the receiver can determine the location of the payload portion or SDUs (e.g., RLC PDU, PDCP PDU) before completing the processing of the entire MAC header. Therefore, PDU processing can be improved and/or simplified at the receiver.

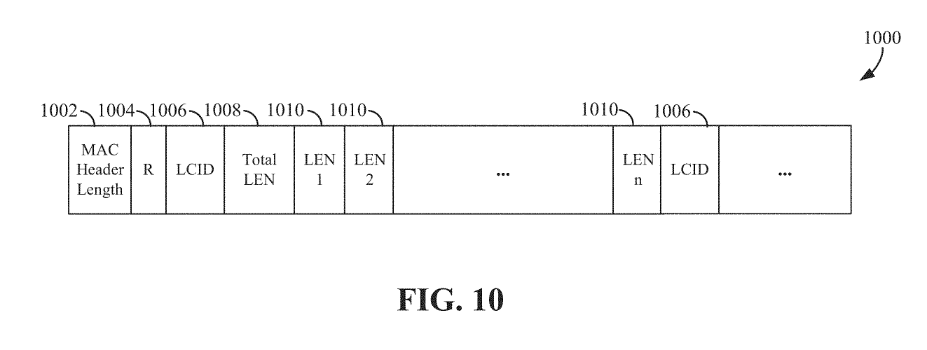

FIG. 10 is a diagram illustrating an exemplary MAC header 1000 in accordance with some aspects of the present disclosure. In some examples, the MAC header 1000 may be the same as the MAC header 702 of FIG. 7. The MAC header 1000 includes various information fields, for example, a MAC header length field 1002, a reserve field (R) 1004, and one or more LCID fields 1006. Associated with each LCID field, the MAC header 1000 may further include a total LEN field 1008 and one or more LEN fields 1010. Each LEN field (e.g., LEN 1, LEN 2, . . . LEN n) indicates the length (e.g., bits) of a corresponding SDU contained in the payload portion of the MAC PDU. The total LEN field 1008 (a quantity field) indicates a total number of LEN fields present in the header for a certain logical channel indicated by the LCID field 1006. The MAC header 1000 may have any suitable number of LEN fields associated with the LCID 1006. In some examples, the header 1000 may have multiple LCID fields, total LEN fields, and various numbers of associated LEN fields. Moreover, each field illustrated in FIG. 10 may contain any number of bits as needed according to various designs. Using the MAC header 1000, a scheduling or scheduled entity can use the same LCID across multiple SDUs associated with the same LCID. Moreover, the MAC header length is known (indicated by the MAC header length 1002) so that the receiver can determine the start of the payload portion (e.g., RLC PDU) before completing the processing of the entire MAC header.

In some examples, some bits of the reserve fields in FIGS. 9 and 10 may be used to implement the total LEN-NUM field 908 or total LEN field 1008 to further reduce the size of the header. That is, the reserve fields may have fewer bits. In some examples, the LEN fields in FIGS. 9 and 10 may contain a field (e.g., a bit) to dynamically indicate the size of the LEN field, instead of using a fixed length for the LEN field. For example, LEN field may be 7 bits or 15 bits long.

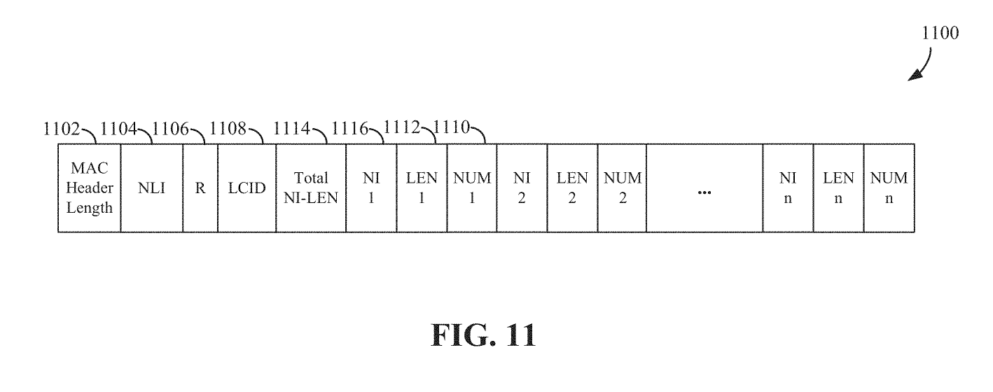

FIG. 11 is a diagram illustrating an exemplary MAC header 1100 in accordance with some aspects of the present disclosure. In some examples, the MAC header 1100 may be the same as the MAC header 702 of FIG. 7. The MAC header 1100 includes various information fields, for example, a MAC header length field 1102, an NLI field 1104, a reserve field (R) 1106, and one or more LCID fields 1108. The MAC header length field 1102 indicates the total length of the entire MAC header 1100. The NLI field 1104 indicates the presence of a NUM field 1110 (e.g., NUM 1, NUM 2, . . . NUM n) and a LEN field 1112 (e.g., LEN 1, LEN 2, . . . LEN n). Each LCID field 1108 may be associated with one or more NUM field and LEN field pairs. The MAC header 1100 may further include a total NI-LEN field 1114 (a quantity field) that indicates the total number of LEN-NUM combos or pairs for the associated LCID field. The MAC header 100 may further include one or more NI fields 1116 (e.g., NI 1, NI 2, . . . NI n) that indicates the presence of the optional NUM field 1110 associated with the LEN field 1112.

FIG. 11 only illustrates one LCID 1108 and its associated fields (e.g., total NI-LEN field 1114, NI field 1116, LEN field 1112, and optional NUM field 1110). In other examples, the MAC header 1100 may have multiple LCIDs 1108 and the above-described fields associated with each LCID. Moreover, each field illustrated in FIG. 11 may contain any number of bits as needed according to various designs.

The above described MAC PDU header formats may be adapted for use in other protocol layers, for example, RLC and PDCP layers. An RLC PDU includes an RLC header and a payload portion that includes one or more RLC SDUs (e.g., PDCP PDUs). For example, an RLC header may be configured to present information about multiple RLC SDUs, such that redundant information may be omitted or reduced in the RLC header.

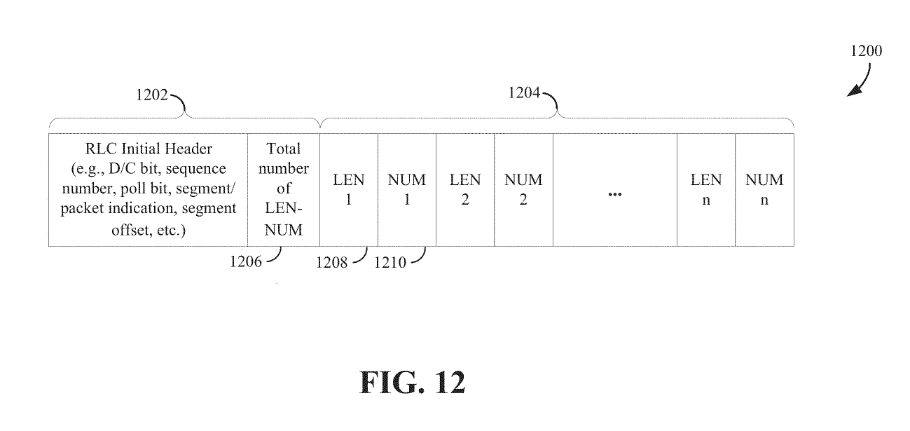

FIG. 12 is a diagram illustrating an exemplary RLC header 1200 in accordance with some aspects of the present disclosure. The RLC header 1200 contains various information fields in a static header portion 1202 and a dynamic header portion 1204. For example, the static header portion 1202 may include a data/control (D/C) bit, a sequence number, a poll bit, a segment/packet indication, a segment offset, and/or other RLC header fields. In one aspect of the disclosure, the static header portion 1202 may include a total LEN-NUM field 1206 (a quantity field) that indicates the number of LEN field 1208 and NUM field 1210 pairs contained in the dynamic header portion 1204. The dynamic header portion 1204 may have one or more pairs of LEN field 1208 and NUM field 1210 (e.g., LEN 1/NUM 1, LEN 2/NUM 2, . . . LEN n/NUM n). The LEN field 1208 indicates a specific SDU length (e.g., bits), and the NUM field 1210 (a quantity field) indicates the number of RLC SDUs with the same length as indicated by the paired LEN field 1208. Each field illustrated in FIG. 12 may have any number of bits in various designs. In some examples, the NUM field 1210 may be optional or removed. The header may include a flag that indicates if a certain NUM field is present. For example, if the header is byte aligned then the LEN field may be 15 bits and the first bit may be a flag F indicating whether the NUM field is present. When the NUM field is not present for a particular LEN field, it indicates that there is only one SDU of that particular length. In some examples, the LEN field 1208 may have a bit to indicate its length (e.g., 7 bits or 15 bits), instead of using a fixed length.

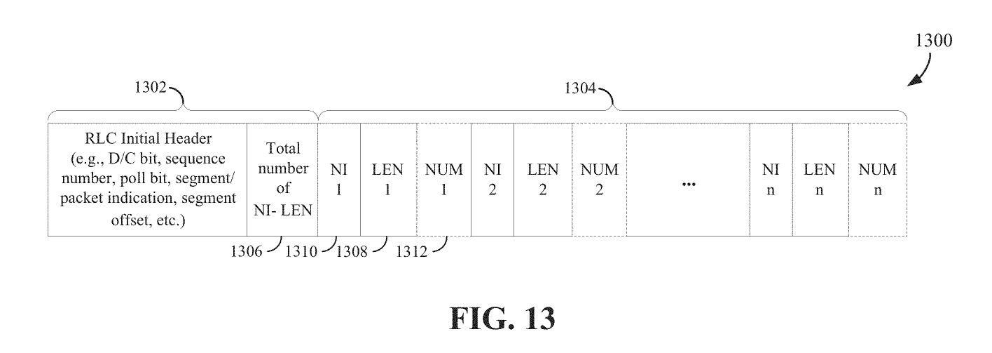

FIG. 13 is a diagram illustrating another exemplary RLC header 1300 in accordance with some aspects of the present disclosure. The RLC header 1300 includes various information fields in a static header portion 1302 and a dynamic header portion 1304. For example, the static header portion 1302 may include a data/control (D/C) bit, a sequence number, a poll bit, a segment/packet indication, a segment offset, and/or other RLC header fields. The static header portion 1302 may have a total NI-LEN field 1306 (a quantity field) that indicates the number of NI field and LEN field pairs contained in the dynamic header portion 1304. For each LEN field 1308, the paired NI field 1310 indicates the presence of an optional NUM field 1312 associated with the LEN field 1308. The LEN field 1308 indicates an SDU length (e.g., bits), and the NUM field 1312 (if presence) indicates the number of SDUs in the payload with the same length as indicated by the paired LEN field 1308. When the NUM field is not present for a certain LEN field, it may indicate that there is only one SDU of that particular length. In some examples, the RLC header 1300 may have any number of NI-LEN pairs (e.g., NI 1/LEN 1, NI 2/LEN 2, . . . NI n/LEN n) and the optional NUM fields (e.g., NUM 1, NUM 2, . . . NUM n). Moreover, each field of the RLC header 1300 may have any number of bits or lengths in various designs.

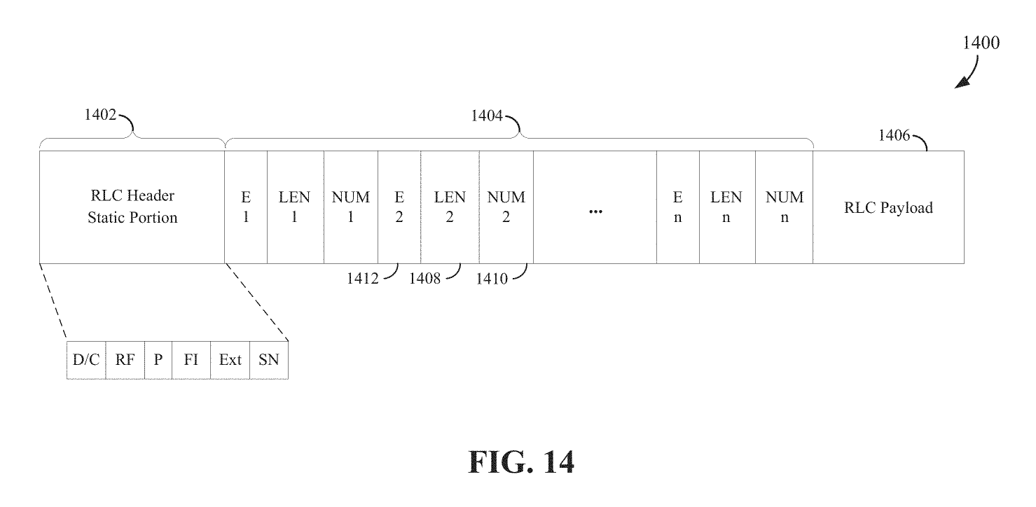

FIG. 14 is a diagram illustrating another example of an RLC header 1400 in accordance with some aspects of the present disclosure. The RLC header 1400 contains a static header portion 1402 and a dynamic header portion 1404. The static header portion 1402 includes various information fields, for example, a data/control (D/C) field, a re-segmentation flag (RF), a polling bit (P), a framing info field (FI), an extension field (Ext), and a sequence number field (SN). The extension field (Ext) indicates the presence or absence of the dynamic header portion 1404 in the RLC header 1400. For example, when the Ext field has a value of 0, an RLC payload portion 1406 immediately follows the static header portion 1402 (i.e., no dynamic header portion 1404); and when the Ext field has a value of 1, one or more sets of (E, LEN, NUM) fields in the dynamic header portion 1404 follow the static header portion 1402. The one or more sets of (E, LEN, NUM) fields provide information on the SDUs in the payload portion 1406.

Each (E, LEN, NUM) set collectively indicates or represents RLC SDUs that have the same size. The LEN field 1408 (e.g., LEN 1, LEN 2, . . . LEN n) indicates the size (bits) of the corresponding RLC SDU(s) contained in the payload portion. The NUM field 1410 indicates the number of SDUs (e.g., one or more SDUs) having the same length as indicated by the LEN field of the same set. The E field 1412 indicates whether the current set is the last set or not. Because the same length indicator LEN can represent multiple SDUs (i.e., NUM is greater than 1), the RLC header size can be reduced. In one specific example, when an RLC PDU has 20 RLC SDUs each of 1500 bytes in size, the extended portion 1404 of the header can use one set of (E, 1500, 20) to represent these SDUs. The RLC header 1400 may have any number of (E, LI, N) sets in various designs.

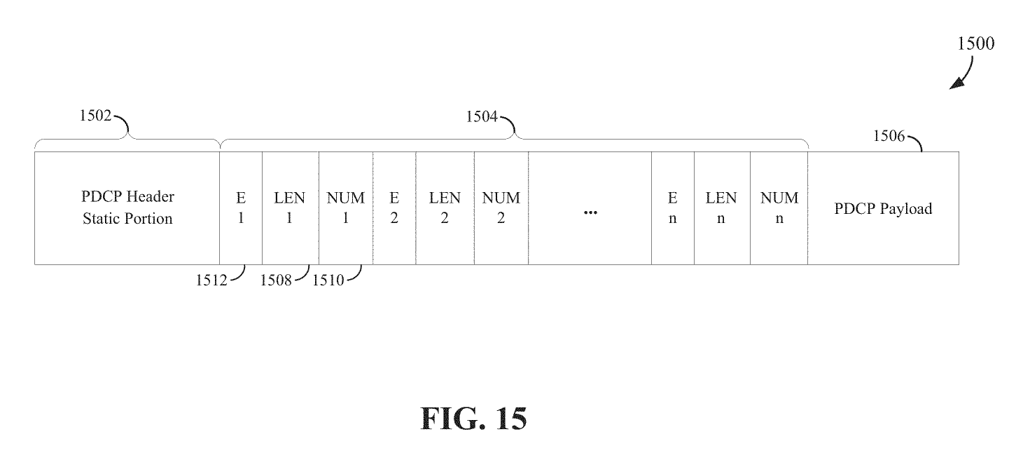

In some aspects of the disclosure, the above described RLC header formats may be adapted, modified, and extended to other PDU types, for example, PDCP and MAC PDUs. FIG. 15 is a diagram illustrating an exemplary PDCP header 1500 in accordance with some aspects of the present disclosure. The PDCP header 1500 contains a static header portion 1502 and a dynamic header portion 1504. The static header portion 1502 includes various information fields, for example, a data/control (D/C) field, a sequence number field (SN) and other PDCP fields. The dynamic header portion 1504 contains one or more sets of (E, LEN, NUM) fields to provide information on the SDUs contained in a payload portion 1506. For example, the SDUs may contain IP packets from an IP layer.

Each set of (E, LEN, NUM) fields collectively indicates or represents multiple

PDCP SDUs that have the same size. The LEN field 1508 (e.g., LEN 1, LEN 2, . . . LEN n) indicates the size (bits) of the corresponding SDU(s) contained in the payload portion 1506. The NUM field 1510 indicates the number of SDUs having the same length as indicated by the LEN field of the same set. The E field 1512 indicates whether the current (E, LEN, NUM) set is the last set or not. Because the same length indicator LEN can be used to provide information on multiple SDUs (i.e., NUM is greater than 1), the PDCP header size can be reduced.

In some aspects of the disclosure, the above-described header formats may be implemented at different protocol layers to improve efficiency and reduce overhead of communication. Moreover, the present disclosure is not limited to the above-described header formats. The various concepts and designs described with the exemplary header formats may be utilized in various ways to reduce per packet processing at the receiver and/or transmitter. Moreover, the proposed header formats enable protocol processing at the MAC, RLC, and/or PDCP layers being less dependent on the number of SDU packets contained in a PDU.

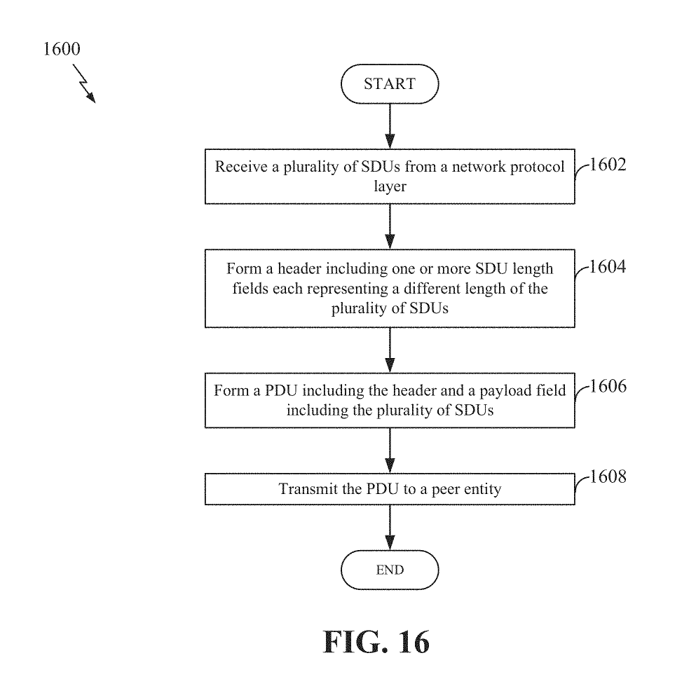

FIG. 16 is a flow chart illustrating an exemplary process 1600 for formatting a protocol data unit (PDU) in accordance with some aspects of the present disclosure. As described below, some or all illustrated features may be omitted in a particular implementation within the scope of the present disclosure, and some illustrated features may not be required for implementation of all embodiments. In some examples, the process 1600 may be carried out by the scheduling entity 400 illustrated in FIG. 4 or scheduled entity 500 illustrated in FIG. 5. In some examples, the process 1600 may be carried out by any suitable apparatus or means for carrying out the functions or algorithm described below.

At block 1602, a device receives a plurality of SDUs from a network protocol layer. The device may be a scheduling entity 400 of FIG. 4 or scheduled entity 500 of FIG. 5. For example, the device may utilize the processor 404/504 (e.g., a PDU coding circuit 440 or 540) to receive SDUs from an IP layer, PDCP layer, or RLC layer. The PDU coding circuit may be configured to implement different network layers or entities similar to those shown in FIG. 3. The PDU coding circuit may have one or more buffers for receiving and storing data packets or SDUs from different network protocol layers.

At block 1604, the device may utilize the processor 404/504 or the PDU coding circuit to form a PDU header including a plurality of SDU length fields each representing a different length of the plurality of SDUs. For example, the SDU length fields may be the same as any of the SDU LEN fields 804, 910, 1010, 1112, 1208, 1308, 1408, and 1508 illustrated in FIGS. 8-15. The PDU coding circuit may determine the length (bits) of each received SDU and create different SDU length fields to represent different SDU lengths.

At block 1606, the device may utilize the processor 404/504 or the PDU coding circuit to form a PDU including the header and a payload field including the plurality of SDUs. For example, the PDU may be a PDCP PDU, RLC PDU, or MAC PDU. The PDU coding circuit may include one or more buffers for concatenating or combining the header and the SDUs. In some examples, the PDU coding circuit may multiplex SDUs from several logical channels into one transport channel.

At block 1608, the device transmits the PDU to a peer entity. For example, the device may utilize a communication circuit 444 or 544 to transmit the PDU to a peer entity. The communication circuit may send the PDU to one or more lower protocol layers that encapsulate one or more PDUs into a lower protocol layer packet or physical layer packet.

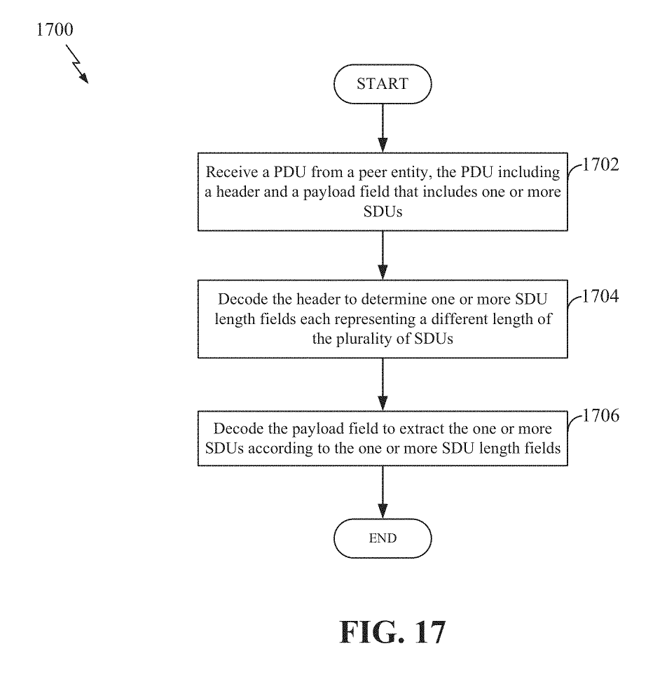

FIG. 17 is a flow chart illustrating an exemplary process 1700 for decoding a packet data unit (PDU) in accordance with some aspects of the present disclosure. As described below, some or all illustrated features may be omitted in a particular implementation within the scope of the present disclosure, and some illustrated features may not be required for implementation of all embodiments. In some examples, the process 1700 may be carried out by the scheduling entity 400 illustrated in FIG. 4 or scheduled entity 500 illustrated in FIG. 5. In some examples, the process 1700 may be carried out by any suitable apparatus or means for carrying out the functions or algorithm described below.

At block 1702, a device receives a PDU from a peer entity. For example, the PDU may be any of the PDCP PDU, RLC PDU, or MAC PDU illustrated in FIGS. 6-15. The PDU includes a header and a payload field that includes one or more SDUs. The receiver may be a scheduling entity 400 of FIG. 4 or a scheduled entity 500 of FIG. 5. For example, the device may utilize a communication circuit 444 or 544 to receive the PDU from the peer entity. The communication circuit may receive the PDU from a lower protocol layer, for example, a physical layer, a MAC layer, an RLC layer, or a PDCP layer.

At block 1704, the device decodes the header to determine a plurality of SDU length fields each representing a different length of the plurality of SDUs. For example, the device may utilize the processor 404 or 504 (e.g., a PDU decoding circuit 442 or 542) to decode the header. The PDU decoding circuit may have a header analyzer configured to extract information fields in the header corresponding to the SDU length fields. For example, the SDU length fields may be the same as any of the SDU LEN fields 804, 910, 1010, 1112, 1208, 1308, 1408, and 1508 illustrated in FIGS. 8-15.

At block 1706, the device decodes the payload field to extract the one or more

SDUs according to the plurality of SDU length fields determined in block 1704. For example, the device may utilize the processor 404/504 or the PDU decoding circuit to extract the one or more SDUs. The PDU decoding circuit may have a payload detector configured to detect the payload and a receive buffer for storing the extracted one or more SDUs.

In one configuration, the apparatus 400 and/or 500 for wireless communication includes means for receiving a plurality of SDUs from a network protocol layer, means for forming a header including a plurality of SDU length fields each representing a different length of the plurality of SDUs, means for forming a PDU including the header and a payload field including the plurality of SDUs, and means for transmitting the PDU to a peer entity.

In one configuration, the apparatus 400 and/or 500 for wireless communication includes means for receiving a PDU from a peer entity, the PDU including a header and a payload field that includes one or more SDUs, means for decoding the header to determine a plurality of SDU length fields each representing a different length of the plurality of SDUs, and means for decoding the payload field to extract the one or more SDUs according to the plurality of SDU length fields

In one aspect, the aforementioned means may be the processor(s) 404 and/or 504 in which the invention resides configured to perform the functions recited by the aforementioned means. In another aspect, the aforementioned means may be a circuit or any apparatus configured to perform the functions recited by the aforementioned means. Of course, in the above examples, the circuitry included in the processors 404 or 504 is merely provided as an example, and other means for carrying out the described functions may be included within various aspects of the present disclosure, including but not limited to the instructions stored in the computer-readable storage medium 406 or 506, or any other suitable apparatus or means described in any one of the FIGS. 1, 2, and/or 3, and utilizing, for example, the processes and/or algorithms described herein in relation to FIGS. 6-15.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in

FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method of wireless communication, comprising:
receiving a plurality of service data units (SDUs) from a network protocol layer;
forming a header comprising a plurality of service data unit (SDU) length fields each representing a different length of the plurality of SDUs, the header configured to indicate a quantity of the SDUs having a same length;
forming a packet data unit (PDU) including the header and a payload field comprising the plurality of SDUs; and
transmitting the PDU to a peer entity.

2. The method of claim 1, wherein forming the header further comprises:
forming one or more logical channel ID (LCID) fields each associated with corresponding one or more of the plurality of SDU length fields.

3. The method of claim 2, wherein forming the header further comprises:
forming a total length quantity field configured to indicate a total number of different SDU length fields associated with the one or more LCID fields.

4. The method of claim 1, wherein forming the header further comprises:
forming one or more SDU quantity fields respectively associated with the plurality of SDU length fields, each SDU quantity field configured to indicate a quantity of the SDUs having a length indicated by the associated SDU length field.

5. The method of claim 4, wherein forming the header further comprises:
forming an indicator configured to indicate the presence of the one or more SDU quantity fields.

6. The method of claim 1, wherein the transmitting the PDU comprises:
transmitting the PDU as a medium access control (MAC) PDU, a radio link control (RLC) PDU, or a packet data convergence protocol (PDCP) PDU.

7. The method of claim 1, wherein forming the header further comprises:
forming a header length field configured to indicate a length of the entire header to facilitate early decoding of the payload field.

8. A method of wireless communication, comprising:
receiving a protocol data unit (PDU) from a peer entity, the PDU comprising a header and a payload field that comprises one or more service data units (SDUs), the header configured to indicate a quantity of the SDUs having a same length;
decoding the header to determine a plurality of service data unit (SDU) length fields each representing a different length of the plurality of SDUs; and
decoding the payload field to extract the one or more SDUs according to the plurality of SDU length fields.

9. The method of claim 8, wherein decoding the header further comprises:
determining one or more logical channel ID (LCID) fields each associated with corresponding one or more of the plurality of SDU length fields.

10. The method of claim 9, wherein decoding the header further comprises:
determining a total length quantity field configured to indicate a total number of different SDU length fields associated with the one or more LCID fields.

11. The method of claim 8, wherein decoding the header further comprises:
determining one or more SDU quantity fields respectively associated with the plurality of SDU length fields, each SDU quantity field configured to indicate a quantity of the SDUs having a length indicated by the associated SDU length field.

12. The method of claim 11, wherein decoding the header further comprises:
determining an indicator configured to indicate the presence of the one or more SDU quantity fields.

13. The method of claim 8, wherein the receiving the PDU comprises:
receiving the PDU as a medium access control (MAC) PDU, a radio link control (RLC) PDU, or a packet data convergence protocol (PDCP) PDU.

14. The method of claim 8, wherein decoding the header further comprises:
determining a header length field configured to indicate a length of the entire header to facilitate early decoding of the payload field.

15. An apparatus comprising:
a communication interface configured for wireless communication;
a memory; and
a processor operatively coupled to the communication interface and the memory,
wherein the processor and the memory are configured to:
receive a plurality of service data units (SDUs) from a network protocol layer;
form a header comprising a plurality of service data unit (SDU) length fields each representing a different length of the plurality of SDUs, the header configured to indicate a quantity of the SDUs having a same length;
form a packet data unit (PDU) including the header and a payload field comprising the plurality of SDUs; and
transmit the PDU to a peer entity.

16. The apparatus of claim 15, wherein the processor and the memory are further configured to:
in the header, form one or more logical channel ID (LCID) fields each associated with corresponding one or more of the plurality of SDU length fields.

17. The apparatus of claim 16, wherein the processor and the memory are further configured to:
in the header, form a total length quantity field configured to indicate a total number of different SDU length fields associated with the one or more LCID fields.

18. The apparatus of claim 15, wherein the processor and the memory are further configured to:
in the header, form one or more SDU quantity fields respectively associated with the plurality of SDU length fields, each SDU quantity field configured to indicate a quantity of the SDUs having a length indicated by the associated SDU length field.

19. The apparatus of claim 18, wherein the processor and the memory are further configured to:
in the header, form an indicator configured to indicate the presence of the one or more SDU quantity fields.

20. The apparatus of claim 15, wherein the processor and the memory are further configured to:
transmit the PDU as a medium access control (MAC) PDU, a radio link control (RLC) PDU, or a packet data convergence protocol (PDCP) PDU.

21. The apparatus of claim 15, wherein the processor and the memory are further configured to:
in the header, form a header length field configured to indicate a length of the entire header to facilitate early decoding of the payload field.

22. An apparatus comprising:
a communication interface configured for wireless communication;
a memory; and
a processor operatively coupled to the communication interface and the memory,
wherein the processor and the memory are configured to:
receiving a protocol data unit (PDU) from a peer entity, the PDU comprising a header and a payload field that comprises one or more service data units (SDUs), the header configured to indicate a quantity of the SDUs having a same length;
decoding the header to determine a plurality of service data unit (SDU) length fields each representing a different length of the plurality of SDUs; and
decoding the payload field to extract the one or more SDUs according to the plurality of SDU length fields.

23. The apparatus of claim 22, wherein the processor and the memory are further configured to:
in decoding the header, determine one or more logical channel ID (LCID) fields each associated with corresponding one or more of the plurality of SDU length fields.

24. The apparatus of claim 23, wherein the processor and the memory are further configured to:
in decoding the header, determine a total length quantity field configured to indicate a total number of different SDU length fields associated with the one or more LCID fields.

25. The apparatus of claim 22, wherein the processor and the memory are further configured to:
in decoding the header, determine one or more SDU quantity fields respectively associated with the plurality of SDU length fields, each SDU quantity field configured to indicate a quantity of the SDUs having a length indicated by the associated SDU length field.

26. The apparatus of claim 25, wherein the processor and the memory are further configured to:
in decoding the header, determine an indicator configured to indicate the presence of the one or more SDU quantity fields.

27. The apparatus of claim 22, wherein the processor and the memory are further configured to:
receive the PDU as a medium access control (MAC) PDU, a radio link control (RLC) PDU, or a packet data convergence protocol (PDCP) PDU.

28. The apparatus of claim 22, wherein the processor and the memory are further configured to:
in decoding the header, determine a header length field configured to indicate a length of the entire header to facilitate early decoding of the payload field.
